(19) United States
(12) Patent Application Publication
(10) Pub. No.: US 2004/0185208 A1
(43) Pub. Date: Sep. 23, 2004

(54) Medical and electrical cord and tubing cover

(76) Inventors: George Austria, Chatsworth, CA (US); Colleen C. Fisher, Spring Grove, PA (US)

Correspondence Address: PERKINS COIE LLP, POST OFFICE BOX 1208, SEATTLE, WA, 98111-1208, US

(21) Appl. No.: 10/804,383

(22) Filed: Mar. 19, 2004

Related U.S. Application Data
(60) Provisional application No. 60/456,758, filed on Mar. 21, 2003.
(60) Provisional application No. 60/504,650, filed on Sep. 19, 2003.

(51) Int. Cl. B32B 9/00

(52) U.S. Cl. 428/40.1; 428/194

(57) ABSTRACT

A disposable medical and electrical cord and tubing cover for covering equipment cords and tubing in a hospital. The cord and tubing cover includes a sheet of flexible non-skid material, such as polyvinyl chloride (PVC) foam, and preferably further includes an adhesive material for securing the cord and tubing cover to the floor or other support surface. The cord and tubing cover may be made of a glow in the dark material, for better visibility in an operating room.

### PRIORITY CLAIM

This application claims priority to U.S. Provisional Application Serial Nos. 60/456,758, filed Mar. 21, 2003 and No. 60/504,650, filed Sep. 19, 2003, both incorporated herein by reference.

### FIELD OF THE INVENTION

The present invention relates generally to cord and tubing covers, and more specifically to a disposable medical and electrical cord and tubing cover to protect hospital personnel who are constantly working around equipment cords and tubing.

### DESCRIPTION OF THE PRIOR ART

Cord covers have been in use for years. The main problems with conventional cord covers are that they are heavy, expensive, and not easily cleaned. Other problems are that many conventional cord covers do not have any way to adhere to a floor, and that they can become slippery when wet.

While existing cord covers may be suitable for the particular purpose to which they address, they are not as suitable for hospital personnel who are constantly working around equipment cords and tubing.

In these respects, the medical and electrical cord and tubing cover according to the present invention substantially departs from the conventional concepts and designs of the prior art, and in so doing provides an apparatus primarily developed for the purpose of hospital personnel safety, as hospital personnel are constantly working around equipment cords and tubing.

### SUMMARY OF THE INVENTION

In view of the foregoing disadvantages inherent in the known types of cord covers now present in the prior art, the present invention provides a new medical and electrical cord and tubing cover construction that can be utilized for protecting hospital personnel from tripping on cords and tubing in the hospital environment.

The general purpose of the present invention, which will be described subsequently in greater detail, is to provide a new medical and electrical cord and tubing cover that has many of the advantages of the cord covers mentioned heretofore, and many novel features that result in a new medical and electrical cord and tubing cover which is not anticipated, rendered obvious, suggested, or even implied by any of the prior art cord covers, either alone or in any combination thereof.

To attain this, the present invention generally comprises a sheet, strip or roll of a flexible material, such as polyvinyl chloride (PVC) foam or another suitable material, and also preferably includes an adhesive material for securing the flexible sheet to a surface, such as a floor in a hospital.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a medical and electrical cord and tubing cover that will overcome the shortcomings of the prior art devices.

An object of the present invention is to provide a medical and electrical cord and tubing cover to protect hospital personnel who are constantly working around equipment cords and tubing.

Another object is to provide a medical and electrical cord and tubing cover that will prevent hospital personnel from tripping over equipment cords and tubing.

Another object is to provide a medical and electrical cord and tubing cover that will keep equipment cords and tubing from being damaged.

Another object is to provide a medical and electrical cord and tubing cover that will help keep cords and tubing secure and in place.

Other objects and advantages of the present invention will become obvious to the reader, and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific constructions illustrated.

### BRIEF DESCRIPTION OF THE DRAWINGS

Various other objects, features, and attendant advantages of the present invention will become fully appreciated as the same becomes better understood when considered in conjunction with the accompanying drawings, in which like reference characters designated the same or similar parts throughout the several views, and wherein:

FIG. 1 is a perspective view of a hospital room including a cord and tubing cover covering equipment cords and tubing on the hospital room floor.

FIG. 2 is a front sectional view of a cord and tubing cover covering cords and tubing resting on a floor surface.

FIG. 3 is a bottom view of a cord and tubing cover having adhesive strips at exterior regions thereof.

FIG. 4 is a perspective view of a cord and tubing cover having a strip of release paper partially peeled away from an adhesive strip on the cord and tubing cover.

FIG. 5 is a perspective view of a cord and tubing cover being removed from a floor or other support surface.

FIG. 6 is a perspective view of a roll of flexible cord and tubing cover.

### DETAILED DESCRIPTION OF THE PREFERRED EMBODIMENT

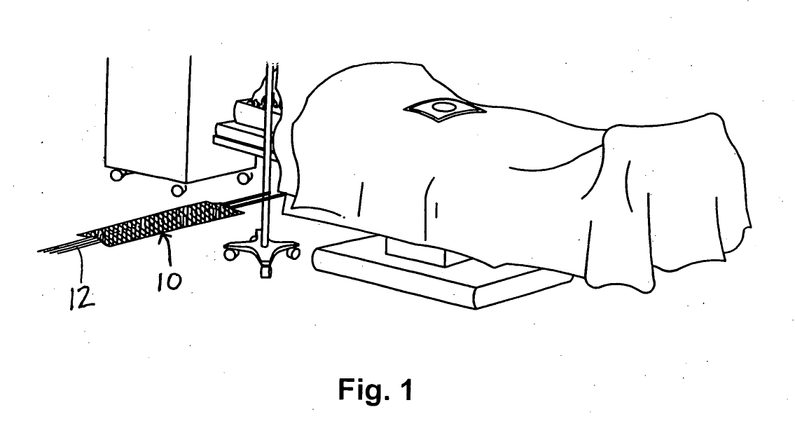

Turning now to the drawings, in which similar reference characters denote similar elements throughout the several views, FIG. 1 illustrates a hospital room including a disposable cord and tubing cover 10 covering cords and tubing 12 on the hospital floor. The cord and tubing cover 10 is preferably a sheet or strip of a flexible non-skid material, such as polyvinyl chloride (PVC) Kittridge foam or another suitable material. PVC foam is a non-skid material that prevents slippage when it is wet or dry. It also grips naturally to various floor or other surface materials. Additionally, PVC foam is light in weight and is durable.

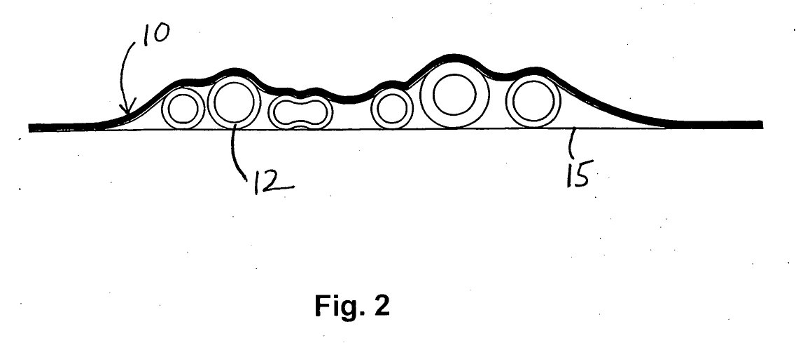

As shown in FIG. 2, the cord and tubing cover 10 is preferably wide enough to cover several cords and tubing 12. To this end, the cord and tubing cover 10 is preferably 4 to 12 inches wide, more preferably 6 to 10 inches wide, more preferably 8 inches wide. The cord and tubing cover 10 is preferably 2 to 6 feet in length, more preferably 2 to 3 feet in length. Any other length cord and tubing cover 10 may be used, however. The cord and tubing cover material may alternatively come in a roll, as described below.

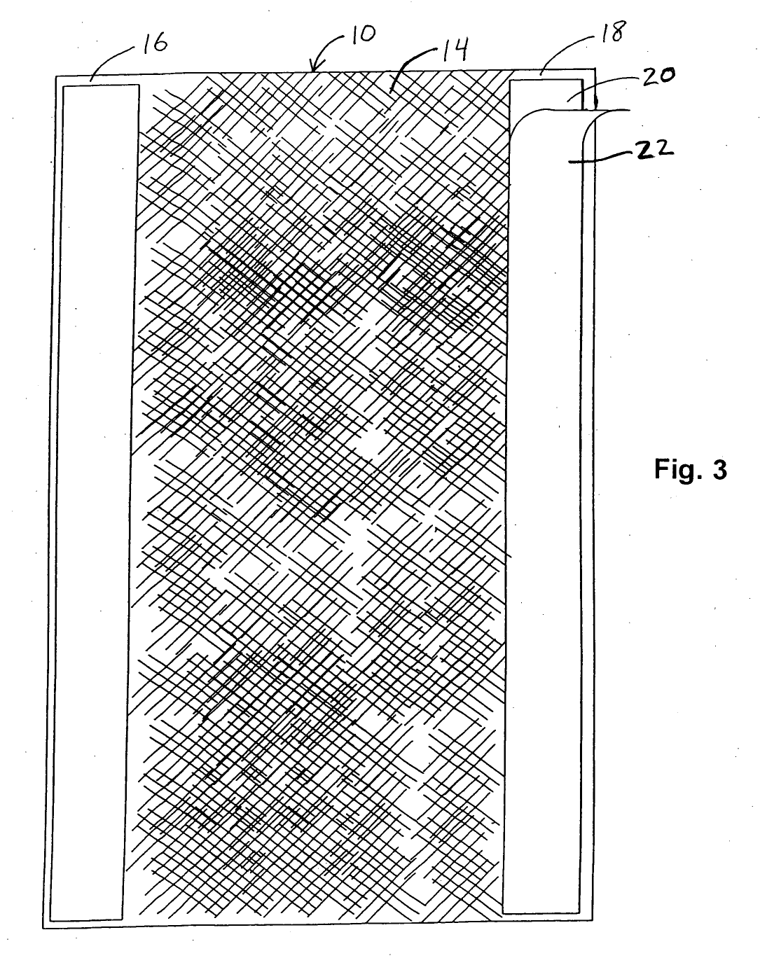

As illustrated in FIG. 3, the bottom surface of the cord and tubing cover 10 includes a pliable interior region 14, for covering one or more cords and tubing 12, that is bounded by two exterior regions 16, 18. In a preferred embodiment, one or both of the exterior regions 16, 18 include an adhesive material, such as two-sided adhesive tape 20, for securing the cord and tubing cover 10 to a floor 15, wall, or other support surface.

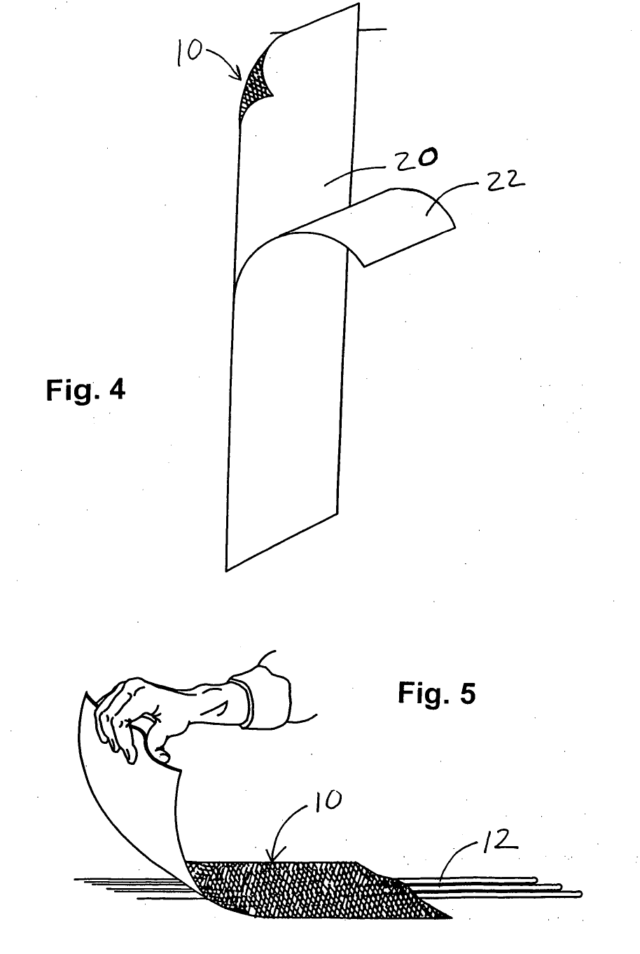

Each strip of two-sided tape 20 is preferably covered by a layer of release paper 22 to allow the cord and tubing cover 10 to be rolled into a roll, as described below, and/or to prevent the cord and tubing cover 10 from adhering to an undesired surface or object. When a user is ready to secure the cord and tubing cover 10 to a support surface, the user can peel away the release paper 22 from the adhesive tape 20 to expose the adhesive material, as shown in FIG. 4. The cord and tubing cover 10 may then be placed over the one or more cords and tubing 12, and the adhesive tape 20 may be adhered to the floor 15 or other support surface.

As an alternative to adhesive tape 20, an adhesive material may be sprayed or otherwise applied onto one or both of the exterior regions 16, 18. The adhesive material used preferably does not leave a residue when removed from the floor 15, wall, or other support surface. In an alternative embodiment, the cord and tubing cover 10 does not include an adhesive material, in which case the non-skid nature of the cord and tubing cover material is relied on to prevent the cord and tubing cover 10 from sliding on the support surface.

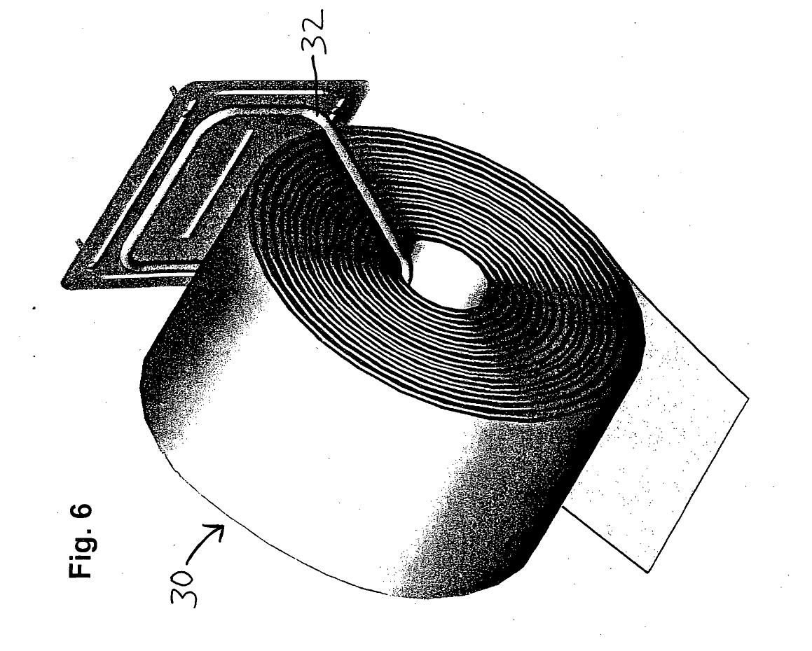

The cord and tubing cover 10 is preferably disposable. After use, the cord and tubing cover 10 may be removed from the floor 15 or other support surface by pulling up either or both ends of the cord and tubing cover 10 from the floor 15 and peeling the cord and tubing cover 10 from the floor 15, as shown in FIG. 5. The cord and tubing cover 10 may then be thrown away or otherwise disposed of.

As illustrated in FIG. 6, in one embodiment, the cord and tubing cover material may be rolled up into a roll 30 and dispensed from a roll-dispensing device 32. The roll 30 preferably includes approximately 100 to 150 feet of cord and tubing cover material, more preferably 125 feet of cord and tubing cover material. Any other length of cord and tubing cover material may alternatively be used. Portions of the cord and tubing cover material may be dispensed from the roll 30 and cut with scissors, or another cutting tool, to any desired length. The roll dispensing device 32 may have a cutting edge, for cutting off a desired length of material. Alternatively, the roll 30 may have perforations at desired intervals, so that sections may be torn off by hand. The cord and tubing cover material, if supplied in sheets or strips, may also have perforations.

The cord and tubing cover material is optionally luminous and glows in the dark, so that hospital employees can see the cord and tubing cover 10 in a dark room. The luminous material is preferably a bright orange color, or other bright color that is easily noticeable in a dark room. Accordingly, the cord and tubing cover 10 minimizes tripping over hospital equipment cords and tubing, and also helps prevent the cords and tubing from being damaged.

Various changes and modifications may of course be made without departing from the spirit and scope of the invention. The invention, therefore, should not be limited, except by the following claims and their equivalents.

What is claimed is:

1. A cord and tubing cover, comprising:
a flexible sheet having a top surface and a bottom surface, with the bottom surface including:
a pliable interior region for covering one or more cords resting on a support surface, and
first and second exterior regions bounding the interior region, wherein at least one of the first and second exterior regions includes an adhesive material for securing the flexible sheet to the support surface.

2. The cord and tubing cover of claim 1 wherein the adhesive material comprises a two-sided adhesive tape.

3. The cord and tubing cover of claim 2 wherein each of the first and second exterior regions includes a strip of the two-sided adhesive tape.

4. The cord and tubing cover of claim 2 further comprising removable release paper on the adhesive tape.

5. The cord and tubing cover of claim 1 wherein the flexible sheet comprises a non-skid material.

6. The cord and tubing cover of claim 5 wherein the non-skid material comprises PVC foam.

7. The cord and tubing cover of claim 1 wherein the flexible sheet comprises a luminous material that glows in the dark.

8. The cord and tubing cover of claim 1 wherein the adhesive material is sprayed onto the flexible sheet.

9. A roll of cord and tubing cover material, comprising:
a roll of flexible non-skid material having a top surface and a bottom surface, with the bottom surface including a pliable interior region for covering one or more cords resting on a support surface.

10. The roll of cord and tubing cover material of claim 9 wherein the bottom surface further includes first and second exterior regions bounding the interior region, with at least one of the first and second exterior regions including an adhesive material for securing the flexible non-skid material to the support surface.

11. The roll of cord and tubing cover material of claim 9 wherein the non-skid material comprises PVC foam.

12. The roll of cord and tubing cover material of claim 9 wherein the non-skid material comprises a luminous material that glows in the dark.

13. The roll of cord and tubing cover material of claim 9 wherein the roll includes 100 to 150 feet of flexible non-skid material.

14. A cord and tubing cover, comprising:
a flexible sheet of non-skid material having a top surface and a bottom surface, with the bottom surface including a pliable interior region for covering one or more cords and tubing resting on a support surface.

15. The cord and tubing cover of claim 14 wherein the non-skid material comprises PVC foam.

16. The cord and tubing cover of claim 14 wherein the flexible sheet comprises a luminous material that glows in the dark

17. The cord and tubing cover of claim 14 further comprising first and second exterior regions bounding the interior region, wherein at least one of the first and second exterior regions includes an adhesive material for securing the flexible sheet to the support surface.

18. The cord and tubing cover of claim 17 wherein the adhesive material comprises a two-sided adhesive tape.

19. The cord and tubing cover of claim 17 wherein the adhesive material is sprayed onto the flexible sheet.
